(19) United States
(12) Patent Application Publication
(10) Pub. No.: US 2024/0170649 A1
(43) Pub. Date: May 23, 2024

(54) Lithium Supplementing Slurry, Positive Electrode Plate, and Lithium Ion Battery

(71) Applicant: JIANGSU ZENERGY BATTERY TECHNOLOGIES CO., LTD., Jiangsu (CN)

(72) Inventors: Bingyang HUA, Dongguan, Guangdong (CN); Wuyuan ZOU, Dongguan, Guangdong (CN)

(21) Appl. No.: 18/282,779

(22) PCT Filed: Oct. 12, 2021
(86) PCT No.: PCT/CN2021/123200

§ 371 Date: Sep. 18, 2023

(30) Foreign Application Priority Data
May 8, 2021 (CN) 202110514352.9

(51) Int. Cl. H01M 4/36; H01M 4/02; H01M 4/485; H01M 4/62; H01M 10/0525

(52) U.S. Cl. CPC H01M 4/366; H01M 4/485; H01M 4/622; H01M 4/624; H01M 10/0525; H01M 2004/021; H01M 2004/028

(57) ABSTRACT

A lithium supplementing slurry, a positive electrode plate, and a lithium ion battery. The lithium supplementing slurry and a positive electrode slurry are separately dispersed and mixed, such that the problems that the positive electrode slurry is difficult to disperse, easy to agglomerate and gel due to direct addition of a lithium supplementing material into the positive electrode slurry are avoided; according to the design of the present disclosure, the lithium supplementing slurry formed by adding the lithium supplementing material, a conductive agent, and a binder may achieve a better dispersion effect; and after the lithium supplementing slurry is coated on a positive electrode coating, the obtained positive electrode plate is lower in impedance and more excellent in lithium supplementing effect. the additive amount of the lithium supplementing material may also be accurately calculated and the residue of the lithium supplementing material after first charging and discharging is effectively reduced.

### CROSS-REFERENCE TO RELATED APPLICATION

This application claims priority to Chinese patent application No. 202110514352.9, filed to the China National Intellectual Property Administration on May 8, 2021 and entitled “Lithium Supplementing Slurry, Positive Electrode Plate, and Lithium Ion Battery”, the disclosure of which is hereby incorporated by reference in its entirety.

### TECHNICAL FIELD

The present disclosure relates to the field of lithium ion batteries, and specifically to a lithium supplementing slurry, a positive electrode plate, and a lithium ion battery.

### BACKGROUND

A Solid Electrolyte Interface (SEI) film is a passivation layer, which is coated on the surface of an electrode material and is formed by the reaction between the electrode material and an electrolyte on a solid-liquid phase interface during the first charging and discharging of a liquid lithium ion battery. The formed passivation film may effectively block solvent molecules from passing through. However, Li+ may be freely embedded and detached via the passivation film, and the passivation film has the characteristics of a solid electrolyte. Therefore, the passivation film is called the “solid electrolyte interface film (SEI film)”. Main components of the SEI film are LiF, Li₂CO₃, lithium alkyl ester, etc. The lithium ions in these products are mainly derived from active lithium in a positive electrode material, directly resulting in reduction of charging and discharging efficiency at the first circle, and subsequently, as the SEI film is dissolved and produced, the loss of the active lithium is more severe. In addition, during the cycling of batteries, a part of the lithium ions cannot be completely detached after being embedded in a negative electrode material, leading to the loss of the active lithium, thereby reducing the charging and discharging efficiency and cycle life.

At present, most enterprises are studying on the choice of lithium supplementing materials and looking for better lithium supplementing materials. Current technologies generally incorporate the lithium supplementing material directly into a positive electrode formulation as a substance, but the lithium supplementing material often has high alkalinity. If the lithium supplementing material is used by directing mixing with a positive electrode active substance, the whole positive electrode slurry is difficult to disperse, and easy to agglomerate and gel, resulting in high resistance and high polarization of manufactured electrode plates.

In addition, there is also related art that prepares a lithium supplementing slurry in advance. For example, Chinese patent CN110838573A discloses a lithium supplementing slurry for a lithium ion energy storage device, and a preparation method and application of the lithium supplementing slurry. The lithium supplementing slurry includes lithium oxalate used as a lithium supplementing active substance, a transition metal compound used as a catalyst, and a solvent. However, such method needs to use an active substance as a catalyst, and only the lithium oxalate is suitable for being used as the lithium supplementing active substance; the additive amount of a lithium supplementing material cannot be accurately designed, effective storage time is short, and adaptability is low; and the problems of high resistance and high polarization still cannot be solved.

In view of this, there is a need for a technical solution to solve the above problems.

### SUMMARY

A first objective of the present disclosure provides a lithium supplementing slurry. The lithium supplementing slurry can be combined with a positive electrode plate in a better state; and a lithium supplementing material used is not limited to lithium oxalate, has wider applicability, and does not contain a catalyst, and the additive amount of the lithium supplementing material may be accurately designed.

In order to implement the above objective, the present disclosure uses the following technical solutions.

A lithium supplementing slurry includes a lithium supplementing material, a conductive agent, and a binder; and the following relational expression is met.

25≤100*(M3*D50)/(M1*B1*M2*\sqrt{B2})≤10000
D50 is an average particle size of the lithium supplementing material.
B1 is a specific surface area of the lithium supplementing material.
B2 is a specific surface area of the conductive agent.
M1 is the ratio of the mass of the lithium supplementing material to the mass of solid components in the lithium supplementing slurry.
M2 is the ratio of the mass of the conductive agent to the mass of the solid components in the lithium supplementing slurry.
M3 is the ratio of the mass of the binder to the mass of the solid components in the lithium supplementing slurry.

Preferably, the lithium supplementing material includes at least one lithium-containing metal oxide that is capable of lithium deintercalation.

Preferably, when the lithium supplementing material comprises at least two lithium-containing metal oxides, the ratio of the mass of the lithium supplementing material to the mass of the solid components in the lithium supplementing slurry is respectively calculated by M1a, M1b, M1c, . . . , M1n, the specific surface area of the lithium supplementing material is calculated by B1a, B1b, B1c, . . . , B1n, and the average particle size of the lithium supplementing material is calculated by D50a, D50b, D50c, . . . , D50n. The following relational expressions are met: M1=M1a+M1b+M1c+ . . . +M1 n; B1=M1a*B1a+M1 b*B1b+ . . . +M1 n*B1 n; and D50=M1a*D50a+M1b*D50b+ . . . +M1n*D50n.

Preferably, the specific surface area B1 of the lithium supplementing material is 0.3-15 m²/g; the average particle size D50 of the lithium supplementing material is 0.5-12 μm; and the ratio M1 of the mass of the lithium supplementing material to the mass of solid components in the lithium supplementing slurry is 70-95%.

Preferably, the lithium-containing metal oxide is any one of lithium phosphate, dilithium hydrogen phosphate, lithium sulfate, lithium sulfite, lithium molybdate, lithium oxalate, lithium titanate, lithium tetraborate, lithium metasilicate, lithium metamanganate, lithium tartrate, and trilithium citrate.

Preferably, the conductive agent consists of at least one conductive agent. When the conductive agent includes at least two conductive agents, the ratio of the mass of the conductive agent to the mass of the solid components in the lithium supplementing slurry is respectively calculated by M2a, M2b, M2c, . . . , M2n, and the specific surface area of the conductive agent is calculated by B2a, B2b, B2c, . . . , B2n. The following relational expressions are met: M2=M2a+M2b+M2c+ . . . +M2n; and B2=M2a*B2a+M2b*B2b+ . . . +M2n*B2n.

Preferably, the specific surface area B2 of the conductive agent is 20-300 m2/g; and the ratio M2 of the mass of the conductive agent to the mass of solid components in the lithium supplementing slurry is 0.1-15%.

Preferably, the conductive agent includes at least one of conductive carbon black, conductive graphite KS-6, conductive graphite SFG-6, Ketjen black EC300J, Ketjen black ECP, Ketjen black ECP-600JD, carbon fiber, carbon nanotubes, graphene, graphene oxide, or vapor grown carbon fiber.

Preferably, the binder is at least one of polyvinylpyrrolidone, polyvinylidene fluoride, polyethylene oxide, polytetrafluoroethylene, sodium carboxymethyl cellulose, or a copolymer of styrene and butadiene. The ratio M3 of the mass of the binder to the mass of the solid components in the lithium supplementing slurry is 0.1-20%.

Preferably, the lithium supplementing slurry further includes a dispersing agent. The ratio of the dispersing agent to the mass of the solid components in the lithium supplementing slurry is 0.1-10%; and the dispersing agent is polyoxyethylene dioleate and/or polytetraethylene glycol monostearate.

Preferably, the lithium supplementing slurry further includes a solvent. The ratio of the solvent to the mass of the lithium supplementing slurry is 20-50%; and the solvent is at least one of water, N-methyl-2-pyrrolidone, tetrahydrofuran, N,N-dimethylformamide, or ethanol.

A second objective of the present disclosure provides a positive electrode plate. The positive electrode plate includes a positive electrode coating and a lithium supplementing coating coated on the positive electrode coating. The lithium supplementing coating is prepared by the lithium supplementing slurry described in any one of the above paragraphs.

Preferably, the thickness of the positive electrode coating and the thickness of the lithium supplementing coating meet the following relational expression: 1/10<the thickness of the lithium supplementing coating/the thickness of the positive electrode coating<⅓.

Preferably, the thickness of the lithium supplementing coating is 5-100 μm; and the thickness of the positive electrode coating is 50-300 μm.

A third objective of the present disclosure provides a lithium ion battery. The lithium ion battery includes the positive electrode plate described in any one of the above paragraphs.

Compared with the related art, the present disclosure at least has the following beneficial effects.
1) According to the present disclosure, the lithium supplementing slurry and the positive electrode slurry are separately dispersed and mixed, such that the problems that the positive electrode slurry is difficult to disperse, easy to agglomerate and gel due to direct addition of a lithium supplementing material into the positive electrode slurry are avoided; and according to the design of the present disclosure, by means of adding the lithium supplementing material, the conductive agent, and the binder, a better dispersion effect may be achieved; and after the lithium supplementing slurry is coated on the positive electrode coating, the obtained positive electrode plate is lower in impedance and more excellent in lithium supplementing effect. In addition, the additive amount of the lithium supplementing material may also be accurately calculated by the relational expression of the present disclosure, such that the residue of the lithium supplementing material after first charging and discharging is effectively reduced, and the utilization rate of the lithium supplementing material is higher.
2) After each substance in the lithium supplementing slurry is rationally configured, the lithium supplementing slurry of the present disclosure has good compatibility with various positive electrode materials and negative electrode materials; and by applying the lithium supplementing slurry of the present disclosure to the lithium ion battery, the first cycle efficiency may be effectively improved, such that the lithium supplementing slurry is close to the first cycle efficiency value of the positive electrode material itself.
3) The lithium supplementing slurry provided in the present disclosure does not contain an active substance catalyst, and a lithium supplementing active substance is not limited to the lithium oxalate, such that the lithium supplementing slurry is wider in applicability and cheaper in cost.

### DETAILED DESCRIPTION OF THE EMBODIMENTS

A first aspect of the present application provides a lithium supplementing slurry. The lithium supplementing slurry includes a lithium supplementing material, a conductive agent, and a binder; and the following relational expression is met.

25≤100*(M3*D50)/(M1*B1*M2*\sqrt{B2})≤10000
D50 is an average particle size of the lithium supplementing material.
B1 is a specific surface area of the lithium supplementing material.
B2 is a specific surface area of the conductive agent.
M1 is the ratio of the mass of the lithium supplementing material to the mass of solid components in the lithium supplementing slurry.
M2 is the ratio of the mass of the conductive agent to the mass of the solid components in the lithium supplementing slurry.
M3 is the ratio of the mass of the binder to the mass of the solid components in the lithium supplementing slurry.

In some embodiments, the above relational expression is met.

100≤100*(M3*D50)/(M1*B1*M2*\sqrt{B2})≤300

300≤100*(M3*D50)/(M1*B1*M2*\sqrt{B2})≤500

500≤100*(M3*D50)/(M1*B1*M2*\sqrt{B2})≤1000

1000≤100*(M3*D50)/(M1*B1*M2*\sqrt{B2})≤1500

1500≤100*(M3*D50)/(M1*B1*M2*\sqrt{B2})≤2000

2000≤100*(M3*D50)/(M1*B1*M2*\sqrt{B2})≤2500

2500≤100*(M3*D50)/(M1*B1*M2*\sqrt{B2})≤3000

3000≤100*(M3*D50)/(M1*B1*M2*\sqrt{B2})≤3500

3500≤100*(M3*D50)/(M1*B1*M2*\sqrt{B2})≤4000

4000≤100*(M3*D50)/(M1*B1*M2*\sqrt{B2})≤4500

4500≤100*(M3*D50)/(M1*B1*M2*\sqrt{B2})≤5000

5000≤100*(M3*D50)/(M1*B1*M2*\sqrt{B2})≤5500

5500≤100*(M3*D50)/(M1*B1*M2*\sqrt{B2})≤6000

6000≤100*(M3*D50)/(M1*B1*M2*\sqrt{B2})≤6500

6500≤100*(M3*D50)/(M1*B1*M2*\sqrt{B2})≤7000

7000≤100*(M3*D50)/(M1*B1*M2*\sqrt{B2})≤7500

7500≤100*(M3*D50)/(M1*B1*M2*\sqrt{B2})≤8000

8000≤100*(M3*D50)/(M1*B1*M2*\sqrt{B2})≤8500

8500≤100*(M3*D50)/(M1*B1*M2*\sqrt{B2})≤9000

9000≤100*(M3*D50)/(M1*B1*M2*\sqrt{B2})≤9500

In some embodiments, the lithium supplementing material includes at least one lithium-containing metal oxide that is capable of lithium deintercalation.

In some embodiments, when the lithium supplementing material comprises at least two lithium-containing metal oxides, the ratio of the mass of the lithium supplementing material to the mass of the solid components in the lithium supplementing slurry is respectively calculated by M1a, M1b, M1c, . . . , M1n, the specific surface area of the lithium supplementing material is calculated by B1a, B1b, B1c, . . . , B1n, and the average particle size of the lithium supplementing material is calculated by D50a, D50b, D50c, . . . , D50n. The following relational expressions are met: M1=M1a+M1b+M1c+ . . . +M1 n; B1=M1a*B1a+M1 b*B1b+ . . . +M1 n*B1 n; and D50=M1a*D50a+M1b*D50b+ . . . +M1n*D50n.

In some embodiments, the specific surface area B1 of the lithium supplementing material may be 0.3-15 m²/g, 0.3-0.5 m²/g, 0.5-1 m²/g, 1-2.5 m²/g, 2.5-5 m²/g, 5-7.5 m²/g, 7.5-9 m²/g, 9-12 m²/g, or 12-15 m²/g; the average particle size D50 of the lithium supplementing material may be 0.5-12 μm, 0.5-1 μm, 1-2.5 μm, 2.5-5 μm, 5-7.5 μm, 7.5-10 μm, or 10-12 μm; and the ratio M1 of the mass of the lithium supplementing material to the mass of solid components in the lithium supplementing slurry may be 70-95%, 70-75%, 75-80%, 80-85%, 85-90%, or 90-95%. if the mass proportion of the lithium supplementing material is too small, it is usually not conducive to the improvement of the energy density of a battery cell, and the internal resistance of the battery cell also increases significantly. More preferably, the specific surface area B1 of the lithium supplementing material may be 0.5-10 m²/g, 0.5-1.5 m²/g, 1.5-3 m²/g, 3-4.5 m²/g, 4.5-6 m²/g, 6-7.5 m²/g, 7.5-9 m²/g, or 9-10 m²/g; the average particle size D50 of the lithium supplementing material may be 1-10 μm, 1-2 μm, 2-3 μm, 3-4 μm, 4-5 μm, 5-6 μm, 6-7 μm, 7-8 μm, 8-9 μm, or 9-10 μm; and the ratio M1 of the mass of the lithium supplementing material to the mass of solid components in the lithium supplementing slurry is 80-90%. Further, the specific surface area B1 of the lithium supplementing material is 0.5-2.5 m²/g; and the average particle size D50 of the lithium supplementing material is 3-6 μm.

In some embodiments, the lithium-containing metal oxide is any one of lithium phosphate, dilithium hydrogen phosphate, lithium sulfate, lithium sulfite, lithium molybdate, lithium oxalate, lithium titanate, lithium tetraborate, lithium metasilicate, lithium metamanganate, lithium tartrate, and trilithium citrate. Compared with patent CN110838573A, in the present disclosure, by means of controlling the properties of related materials such as the lithium supplementing material and the conductive agent, various lithium supplementing materials may be effectively applied to the lithium supplementing slurry, and are not only limited to a lithium oxalate lithium supplementing slurry.

In some embodiments, the conductive agent consists of at least one conductive agent. When the conductive agent includes at least two conductive agents, the ratio of the mass of the conductive agent to the mass of the solid components in the lithium supplementing slurry is respectively calculated by M2a, M2b, M2c, . . . , M2n, and the specific surface area of the conductive agent is calculated by B2a, B2b, B2c, . . . , B2n. The following relational expressions are met: M2=M2a+M2b+M2c+ . . . +M2n; and B2=M2a*B2a+M2b*B2b+ . . . +M2n*B2n.

In some embodiments, the specific surface area B2 of the conductive agent may be 20-300 m²/g, 20-50 m²/g, 50-80 m²/g, 80-100 m²/g, 100-130 m²/g, 130-150 m²/g, 150-180 m²/g, 180-20 m²/g, 200-230 m²/g, 230-250 m²/g, 250-280 m²/g, or 280-300 m²/g; and the ratio M2 of the mass of the conductive agent to the mass of solid components in the lithium supplementing slurry may be 0.1-15%, 0.1-1%, 1-2%, 2-3%, 3-4%, 4-5%, 5-6%, 6-7%, 7-8%, 8-9%, 9-10%, 10-11%, 11-12%, 12-13%, 13-14%, or 14-15%. More preferably, the specific surface area B2 of the conductive agent may be 50-120 m²/g, 50-60 m²/g, 60-70 m²/g, 70-80 m²/g, 80-90 m²/g, 90-100 m²/g, 100-110 m²/g, or 110-120 m²/g; and the ratio M2 of the mass of the conductive agent to the mass of solid components in the lithium supplementing slurry may be 5-10%, 5-5.5%, 5.5-6%, 6-6.5%, 6.5-7%, 7-7.5%, 7.5-8%, 8-8.5%, 8.5-9%, 9-9.5%, or 9.5-10%. When the specific surface area of the conductive agent is too large, it is easy to cause the lithium supplementing slurry to not easy to disperse, thus lithium supplementing efficiency is affected; and when the specific surface area of the conductive agent is too small, the specific surface area of the lithium supplementing material is close to that of the conductive agent, and an electrostatic attraction force is relatively weak. In one aspect, the conductive agent cannot be well adsorbed on the surface of the lithium supplementing material, such that the utilization of lithium capacity cannot be well promoted; and in another aspect, a conductive network cannot be well formed, thus affecting the lithium supplementing efficiency. Therefore, even if the additive amount of the lithium supplementing material is accurately calculated, a lithium supplementing effect is affected due to insufficient use of the lithium supplementing material. Likewise, the additive amount of the conductive agent has large impact on the dispersion, mixing and lithium supplementing effect of the lithium supplementing material; and if the ratio is too large, uneven dispersion of the lithium supplementing slurry is caused, thereby affecting the lithium supplementing efficiency. In addition, the additive amount of the conductive agent affects the internal resistance of the battery cell and the energy density of the battery cell. Generally, when the proportion of the conductive agent is higher, the proportion of the lithium supplementing material is correspondingly decreased, the resistance of the electrode plate is smaller, and the energy density of the battery cell is reduced to a certain extent. On the contrary, when the proportion of the conductive agent is lower, the proportion of the lithium supplementing material is correspondingly increased, the resistance of the electrode plate is larger, and the energy density of the battery cell is increased to a certain extent.

In some embodiments, the conductive agent includes at least one of conductive carbon black, conductive graphite KS-6, conductive graphite SFG-6, Ketjen black EC300J, Ketjen black ECP, Ketjen black ECP-600JD, carbon fiber, carbon nanotubes, graphene, graphene oxide, or vapor grown carbon fiber. The conductive agent may prevent a dispersing agent from completely coating the lithium supplementing material, such that the utilization of lithium capacity is well promoted. The conductive agent used in the present disclosure is a carbon material, and carbon atoms of the carbon material are sp²-hybridized. The conductive agent carries negative charges on the surface, and may be adsorbed on the surface of the lithium supplementing material by means of static electricity, so as to form a conductive layer, thereby preventing the lithium supplementing material from completely being coated by the dispersing agent. In addition, an enough electronic channel is also provided by the conductive agent, such that the probability that an electrolyte is in contact with the lithium supplementing material is greatly increased, thereby further increasing the utilization rate of lithium.

In some embodiments, the binder is at least one of polyvinylpyrrolidone, polyvinylidene fluoride, polyethylene oxide, polytetrafluoroethylene, sodium carboxymethyl cellulose, or a copolymer of styrene and butadiene. The ratio M3 of the mass of the binder to the mass of the solid components in the lithium supplementing slurry may be 0.1-20%, 0.1-2.5%, 2.5-5%, 5-7.5%, 7.5-10%, 10-12.5%, 12.5-15%, 15-17.5%, or 17.5-20%. Preferably, the ratio M3 of the mass of the binder to the mass of the solid components in the lithium supplementing slurry may be 5-15%, 5-6%, 6-7%, 7-8%, 8-9%, 9-10%, 10-11%, 11-12%, 12-13%, 13-14%, or 14-15%. The binder not only has a bonding effect, but also has a dispersing effect. By means of the combined action with the dispersing agent, larger steric hindrance is formed between particles of the lithium supplementing material, such that the lithium supplementing slurry is dispersed more evenly. When the ratio of the binder is too small, the bonding effect is insufficient, resulting in larger resistance of the electrode plate, thereby affecting the lithium supplementing effect; and when the ratio is too large, high polarization of the battery is caused, thereby also affecting the lithium supplementing effect.

In some embodiments, the lithium supplementing slurry further includes a dispersing agent. The dispersing agent is polyoxyethylene dioleate and/or polytetraethylene glycol monostearate. The ratio of the dispersing agent to the mass of the solid components in the lithium supplementing slurry may be 0.1-10%, 0.1-1%, 1-2.5%, 2.5-5%, 5-7.5%, or 7.5-10%. Preferably, the ratio of the dispersing agent to the mass of the solid components in the lithium supplementing slurry may be 3-6%, 3-3.5%, 3.5-4%, 4-4.5%, 4.5-5%, 5-5.5%, or 5.5-6%. Such dispersing agent of nonionic surfactant may facilitate the stable and even dispersion of the lithium supplementing slurry. When the dispersing agent is excessive, the dispersing agent would tightly coat the lithium supplementing material, which can prevent the capacity of the lithium from being used, such that the number of lithium ion channels and electronic conductivity are reduced. And when the dispersing agent is too less, due to its short molecular chain, it cannot well play a role of steric hindrance, such that the sable lithium supplementing slurry cannot be formed.

In some embodiments, the lithium supplementing slurry further includes a solvent. The solvent is at least one of water, N-methyl-2-pyrrolidone, tetrahydrofuran, N,N-dimethylformamide, or ethanol. The ratio of the solvent to the mass of the lithium supplementing slurry may be 20-50%, 20-25%, 25-30%, 30-35%, 35-40%, 40-45%, or 45-50%. Preferably, the ratio of the solvent to the mass of the lithium supplementing slurry may be 25-40%, 25-27.5%, 27.5-30%, 30-32.5%, 32.5-35%, 35-37.5%, or 37.5-40%. When the content of the solvent is relatively low, the viscosity of the lithium supplementing slurry is relatively high, and the solid content is too high, easily result in an uneven stirring. And when the content of the solvent is too high, the viscosity of the lithium supplementing slurry is too low, the flowability of the slurry is too well during coating, also causing an uneven coating of the slurry. The solvent with such ratio may be better mixed with the lithium supplementing material, the conductive agent and the dispersing agent, so as to form a lithium supplementing slurry with suitable viscosity. The lithium supplementing slurry may be uniformly coated on the positive electrode coating, so as to guarantee the lithium supplementing effect.

A second aspect of the present application provides a positive electrode plate. The positive electrode plate includes a positive electrode current collector, a positive electrode coating provided on the positive electrode current collector, and a lithium supplementing coating coated on the positive electrode coating. The lithium supplementing coating is prepared by the lithium supplementing slurry described in the present application. The lithium supplementing slurry may be coated on the positive electrode coating by means of continuous coating, gap coating or spot coating, and specifically, by means of any one of silk-screen printing, gravure coating, slot-die coating, and transfer coating.

The positive electrode coating contains a positive electrode active substance; and the specific type of the positive electrode active substance is not limited and may be selected according to requirements. For example, the positive electrode active substance of the positive electrode coating may include, but is not limited to, a combination of one or more of a layered positive electrode active substance, a spinel-type positive electrode active substance, an olivine-type positive electrode active substance, and polymetallic sulphide. More specifically, the positive electrode active substance may include, but is not limited to, one or more of compounds shown as a chemical formula of LiₐNiₓCo_{y}M_{z}O_{2-b}N_{b} (wherein 0.95≤a≤1.2, x>0, y≥0, z≥0, x+y+z=1, 0≤b≤1, M is selected from one or more of Mn and Al, and N is selected from one or more of F, P, and S). The positive electrode active substance may also include, but is not limited to, one or more of LiC_{O}O₂, LiNiO₂, LiVO₂, LiCrO₂, LiMn₂O₄, LiCoMnO₄, Li₂NiMn₃O₈, LiNi_{0.5}Mn_{1.5}O₄, LiCoPO₄, LiMnPO₄, LiFePO₄, LiNiPO₄, LiCoFSO₄, CuS₂, FeS₂, MoS₂, NiS, and TiS₂. The positive electrode active substance may also be modified. A method for modifying the positive electrode active substance should be known to those skilled in the art. For example, the positive electrode active substance may be modified by methods of coating, doping, etc. Materials used for modification may include, but are not limited to one or more of Al, B, P, Zr, Si, Ti, Ge, Sn, Mg, Ce, and W.

In some embodiments, the thickness of the positive electrode coating and the thickness of the lithium supplementing coating meet the following relational expression: 1/10<the thickness of the lithium supplementing coating/the thickness of the positive electrode coating<⅓. If the thickness ratio is too low, the lithium supplementing coating is relatively thin, the lithium supplementing effect cannot be well achieved; and if the thickness ratio is too high, the lithium supplementing coating may be too thick, the thickness of the cathode coating is compressed, and it does not facilitate the enhancement of the energy density of the battery cell, and the internal resistance of the battery cell also increases significantly.

In some embodiments, the thickness of the positive electrode coating and the thickness of the lithium supplementing coating may meet the following relational expressions: 1/10<the thickness of the lithium supplementing coating/the thickness of the positive electrode coating<⅛, ⅛<the thickness of the lithium supplementing coating/the thickness of the positive electrode coating<⅕, and ⅕<the thickness of the lithium supplementing coating/the thickness of the positive electrode coating<⅓.

In some embodiments, the thickness of the lithium supplementing coating may be 5-100 μm, 5-15 μm, 15-30 μm, 30-45 μm, 45-60 μm, 60-75 μm, or 75-100 μm; and the thickness of the positive electrode coating may be 50-300 μm, 50-80 μm, 80-100 μm, 100-130 μm, 130-160 μm, 160-200 μm, 200-230 μm, 230-260 μm, or 260-300 μm. More preferably, the thickness of the lithium supplementing coating may be 10-50 μm, 10-15 μm, 15-20 μm, 20-30 μm, 30-35 μm, 35-40 μm, 40-45 μm, or 45-50 μm; and the thickness of the positive electrode coating may be 100-200 μm, 100-110 μm, 110-120 μm, 120-130 μm, 130-140 μm, 140-150 μm, 150-160 μm, 160-170 μm, 170-180 μm, 180-190 μm, or 190-200 μm.

A third aspect of the present application provides a lithium ion battery. The lithium ion battery includes the positive electrode plate described above in the present application, a negative electrode plate, and a separator. A method for preparing the lithium ion battery should be known to those skilled in the art. For example, the positive electrode plate, the separator and the negative electrode plate may respectively be layers, such that the positive electrode plate, the separator and the negative electrode plate may be successively stacked after being cutting into target sizes, or may further be wound to the target sizes, so as to form a battery cell, and may further be combined with an electrolyte to form a lithium ion battery. The specific type of the lithium ion battery is not specifically limited, for example, may include, but is not limited to, a cylindrical battery, an aluminum housing battery, or a pouch battery.

The negative electrode plate usually includes a negative current collector and a negative active substance layer located on the surface of the negative current collector. The negative active substance layer usually includes a negative active substance. The negative active substance may be various materials that are suitable for the negative active substance of the lithium ion battery in the art, for example, may include, but is not limited to, one or several of graphite, soft carbon, hard carbon, carbon fiber, mesocarbon microbeads, a silica-based material, a tin-based material, lithium titanate, or other metal that can form alloy with lithium. The graphite may be selected from one or several of artificial graphite, natural graphite, and modified graphite. The silica-based material may be selected from one or several of monomeric silicon, a silicon oxide compound, a silicon carbon complex, and silicon alloy. The tin-based material may be selected from one or several of monolithic tin, a tin oxygen compound, and tin alloy. The negative current collector is usually a structure or part for collecting currents. The negative current collector may be various materials that are suitable for being used as the negative current collector of the lithium ion battery in the art. For example, the negative current collector may include, but is not limited to, metallic foil, and more specifically, may include, but is not limited to, copper foil.

The separator may be various materials that are suitable for a lithium ion battery separator, for example, may include, but is not limited to, a combination of one or more of polyethylene, polypropylene, polyvinylidene fluoride, aramid fiber, polyethylene terephthalate, polytetrafluoroethylene, polyacrylonitrile, polyimide, polyamide, polyester, and natural fiber.

In order to make the technical solutions and advantages of the present disclosure clearer, the present disclosure and beneficial effects thereof are further described below in conjunction with specific embodiments, but the implementations of the present disclosure are not limited thereto.

### Embodiment 1

A lithium ion battery includes a positive electrode plate, a negative electrode plate, and a separator provided between the positive electrode plate and the negative electrode plate. In the positive electrode plate, lithium iron phosphate as a positive electrode active substance is used to prepare a positive electrode coating; then the lithium supplementing slurry is squeezed and coated on the positive electrode coating, so as to obtain a lithium supplementing coating; the thickness of the lithium supplementing coating/the thickness of the positive electrode coating is controlled to be ⅛; in the negative electrode plate, graphite of 350 mAh/g is used as a negative electrode material; and the lithium ion power battery is obtained by means of assembling.

Likewise, the lithium ion power batteries of Embodiments 2-20 are prepared according to the settings of Embodiment 1.

### Comparative Example 1

The difference between this comparative example and Embodiment 1 lies in that, the positive electrode plate in this comparative example does not include the lithium supplementing coating.

The other is similar to Embodiment 1, which is not described herein again.

### Comparative Example 2

The difference between this comparative example and Embodiment 1 lies in that, the positive electrode plate in this comparative example includes a lithium supplementing material; and the lithium supplementing material is first mixed with positive electrode slurry, and then coated.

The other is similar to Embodiment 1, which is not described herein again.

Specifically, the relevant settings and performance test results under the same conditions for Embodiment 1-20 and Comparative examples 1-2 are shown in Table 1 below. A relational expression 1 refers to 100*(M3*D50)/(M1*B1*M2*\sqrt{B2}).

TABLE 1

| | | Lithium | | | First circle | First circle | |
|---|---|---|---|---|---|---|---|
| | | supple- | | | charging | discharging | |
| | Positive | menting | Relational | Negative | capacity | capacity | First |
| | electrode | material | expression | electrode | per gram, | per gram | circle |
| No. | material | content | 1 | material | (mAh/g) | (mAh/g) | efficiency |
| Com - | LFP | / | / | Graphite | 158.2 | 144.1 | 91.09% |
| parative | | | | | | | |
| example | | | | | | | |
| 1 | | | | | | | |
| Com- | LFP | 85% | / | Graphite | 157.9 | 144.3 | 91.12% |
| parative | | | | | | | |
| example | | | | | | | |
| 2 | | | | | | | |
| Embodi- | LFP | 70% | 56 | Graphite | 155.5 | 141.2 | 91.23% |
| ment 1 | | | | | | | |
| Embodi- | LFP | 70% | 436 | Graphite | 156.2 | 145.9 | 93.46% |
| ment 2 | | | | | | | |
| Embodi- | LFP | 70% | 3326 | Graphite | 157.2 | 148.8 | 94.21% |
| ment 3 | | | | | | | |
| Embodi- | LFP | 70% | 6102 | Graphite | 159.3 | 154.8 | 95.57% |
| ment 4 | | | | | | | |
| Embodi- | LFP | 70% | 9113 | Graphite | 158.6 | 149.6 | 95.05% |
| ment 5 | | | | | | | |
| Embodi- | LFP | 80% | 59 | Graphite | 155.6 | 142.6 | 91.30% |
| ment 6 | | | | | | | |
| Embodi- | LFP | 80% | 648 | Graphite | 156.5 | 146.3 | 94.01% |
| ment 7 | | | | | | | |
| Embodi- | LFP | 80% | 3158 | Graphite | 157.1 | 148.2 | 94.63% |
| ment 8 | | | | | | | |
| Embodi- | LFP | 80% | 6284 | Graphite | 159.5 | 155.1 | 97.03% |
| ment 9 | | | | | | | |
| Embodi- | LFP | 80% | 9058 | Graphite | 158.6 | 151 | 95.20% |
| ment 10 | | | | | | | |
| Embodi- | LFP | 85% | 45 | Graphite | 156.5 | 142.9 | 91.31% |
| ment 11 | | | | | | | |
| Embodi- | LFP | 85% | 531 | Graphite | 156.1 | 146.8 | 94.04% |
| ment 12 | | | | | | | |
| Embodi- | LFP | 85% | 3642 | Graphite | 157.6 | 149.6 | 94.92% |
| ment 13 | | | | | | | |
| Embodi- | LFP | 85% | 5984 | Graphite | 159.7 | 154.9 | 96% |
| ment 14 | | | | | | | |
| Embodi- | LFP | 85% | 8932 | Graphite | 158.9 | 151.2 | 95.15% |
| ment 15 | | | | | | | |
| Embodi- | LFP | 90% | 33 | Graphite | 155.9 | 145.4 | 93.26% |
| ment 16 | | | | | | | |
| Embodi- | LFP | 90% | 762 | Graphite | 157.3 | 149.3 | 94.91% |
| ment 17 | | | | | | | |
| Embodi- | LFP | 90% | 2986 | Graphite | 159.8 | 155.3 | 97.18% |
| ment 18 | | | | | | | |
| Embodi- | LFP | 90% | 6372 | Graphite | 159 | 155.8 | 97.99% |
| ment 19 | | | | | | | |
| Embodi- | LFP | 90% | 9238 | Graphite | 157.5 | 150.3 | 95.43% |
| ment 20 | | | | | | | |

### Embodiment 21

A lithium ion battery includes a positive electrode plate, a negative electrode plate, and a separator provided between the positive electrode plate and the negative electrode plate. In the positive electrode plate, a ternary material as a positive electrode active substance is used to prepare a positive electrode coating; then the lithium supplementing slurry is squeezed and coated on the positive electrode coating, so as to obtain a lithium supplementing coating; the thickness of the lithium supplementing coating/the thickness of the positive electrode coating is controlled to be ⅕; in the negative electrode plate, silica of 650 mAh/g is used as a negative electrode material; and the lithium ion power battery is obtained by means of assembling.

Likewise, the lithium ion power batteries of Embodiments 22-25 are prepared according to the settings of Embodiment 21.

### Comparative Example 3

The difference between this comparative example and Embodiment 21 lies in that, the positive electrode plate in this comparative example does not include the lithium supplementing coating.

The other is similar to Embodiment 21, which is not described herein again.

### Comparative Example 4

The difference between this comparative example and Embodiment 21 lies in that, the positive electrode plate in this comparative example includes a lithium supplementing material; and the lithium supplementing material is first mixed with positive electrode slurry, and then coated.

The other is similar to Embodiment 21, which is not described herein again.

Specifically, the relevant settings and performance test results under the same conditions for Embodiment 21-35 and Comparative examples 3-4 are shown in Table 2 below. A relational expression 1 refers to 100*(M3*D50)/(M1*B1*M2*\sqrt{B2}).

TABLE 2

| | | Lithium | | | First circle | First circle | |
|---|---|---|---|---|---|---|---|
| | | supple- | | | charging | discharging | |
| | Positive | menting | Relational | Negative | capacity | capacity | First |
| | electrode | material | expression | electrode | per gram | per gram | circle |
| No. | material | content | 1 | material | (mAh/g) | (mAh/g) | efficiency |
| Com- | NCM | / | / | Silica | 194.8 | 143.5 | 73.67% |
| parative | | | | | | | |
| example | | | | | | | |
| 3 | | | | | | | |
| Com- | NCM | 85% | / | Silica | 194.6 | 144.8 | 74.82% |
| parative | | | | | | | |
| example | | | | | | | |
| 4 | | | | | | | |
| Embodi- | NCM | 75% | 37 | Silica | 194.2 | 151.8 | 78.59% |
| ment 21 | | | | | | | |
| Embodi- | NCM | 75% | 894 | Silica | 195.1 | 157.8 | 80.36% |
| ment 22 | | | | | | | |
| Embodi- | NCM | 75% | 2941 | Silica | 195.2 | 161.7 | 83.49% |
| ment 23 | | | | | | | |
| Embodi- | NCM | 75% | 5367 | Silica | 195.3 | 168.9 | 87.59% |
| ment 24 | | | | | | | |
| Embodi- | NCM | 75% | 8147 | Silica | 195.0 | 169.7 | 86.89% |
| ment 25 | | | | | | | |
| Embodi- | NCM | 85% | 51 | Silica | 194.4 | 154.6 | 79.53% |
| ment 26 | | | | | | | |
| Embodi- | NCM | 85% | 999 | Silica | 195.3 | 159.2 | 81.52% |
| ment 27 | | | | | | | |
| Embodi- | NCM | 85% | 2763 | Silica | 195 | 164.3 | 84.26% |
| ment 28 | | | | | | | |
| Embodi- | NCM | 85% | 5123 | Silica | 195.2 | 171.8 | 88.01% |
| ment 29 | | | | | | | |
| Embodi- | NCM | 85% | 8241 | Silica | 194.9 | 170.4 | 87.43% |
| ment 30 | | | | | | | |
| Embodi- | NCM | 90% | 28 | Silica | 195.4 | 155.7 | 79.68% |
| ment 31 | | | | | | | |
| Embodi- | NCM | 90% | 1112 | Silica | 194.7 | 162.4 | 83.41% |
| ment 32 | | | | | | | |
| Embodi- | NCM | 90% | 3268 | Silica | 194.3 | 167.1 | 86.00% |
| ment 33 | | | | | | | |
| Embodi- | NCM | 90% | 5347 | Silica | 195.1 | 173.3 | 88.83% |
| ment 34 | | | | | | | |
| Embodi- | NCM | 90% | 9104 | Silica | 193.9 | 171.1 | 88.24% |
| ment 35 | | | | | | | |

From comparison of Embodiments 1-35 and Comparative examples 1-4, it can be seen that, the lithium supplementing material added in the relational expression of the present disclosure is met, and the first circle discharging capacity and the first circle efficiency of the obtained lithium ion battery are all effectively improved, such that it indicates that the lithium supplementing coating of the present disclosure can well be fused with the positive electrode coating, the utilization rate of the lithium supplementing material is higher, the lithium supplementing efficiency is higher, the lithium supplementing material is not limited to lithium oxalate, and wider applicability is realized. For example, in Embodiments 1-20 and Comparative examples 1-2, the first circle efficiency of a battery of a lithium iron phosphate and graphite system is 91.1% without adding the lithium supplementing slurry; however, after the lithium supplementing slurry is introduced, the maximum first circle efficiency can be improved to 97.9%, which is close to the first cycle efficiency value of the lithium iron phosphate material. Likewise, the first circle efficiency of a battery of a ternary NCM523 material and silica negative electrode system is 73.6% without adding the lithium supplementing slurry; however, after the lithium supplementing slurry is introduced, the maximum first circle efficiency can be improved to 88.83%, which is close to the first cycle efficiency value of the ternary NCM523 material.

In addition, from Embodiments 1-35, it can be seen that, with the same content of the lithium supplementing material and the changed content of the conductive agent, the binder and the dispersing agent, insofar as the relational expression of the present disclosure is met, with the rising of the current relational expression, the lithium supplementing effect of the lithium ion battery shows a trend of increasing first and then decreasing. This is mainly because the lithium supplementing effect is affected by a variety of factors, the specific surface area of the lithium supplementing material, the particle size of the lithium supplementing material, the additive amount of the lithium supplementing material, the specific surface area of the conductive agent, the additive amount of the conductive agent and the additive amount of the binder, etc. All have an impact on the lithium supplementing effect, and the first cycle efficiency value can be maximized by synchronously controlling these factors. In addition, with the increasing of the content of the lithium supplementing material, the lithium supplementing effect of the lithium ion battery also shows the trend of increasing first and then decreasing, which is also the result of the combined effect of the above various factors.

Based on the above analysis, according to the design of the present disclosure, by means of adding the lithium supplementing material, the conductive agent, the binder and the dispersing agent, a better dispersion effect may be achieved, and after the lithium supplementing slurry is coated on the positive electrode coating, the obtained positive electrode plate is lower in impedance and more excellent in lithium supplementing effect, such that the first cycle efficiency may be effectively improved, and the lithium supplementing slurry is close to a first cycle efficiency value of the positive electrode material itself.

In accordance with the foregoing disclosure and instructions of the specification, a person skilled in the art of the present disclosure is also able to make changes and modifications to the above implementations. Therefore, the present disclosure is not limited to the above specific implementations, and any obvious improvements, substitutions or variations made by a person skilled in the art on the basis of the present disclosure fall within the scope of protection of the present disclosure. Furthermore, although some specific terms are used in this specification, these terms are used for ease of description only and do not constitute any limitation to the present disclosure.

What is claimed is:

1. A lithium supplementing slurry, comprising a lithium supplementing material, a conductive agent, and a binder, wherein the following relational expression is met:
25≤100*(M3*D50)/(M1*B1*M2*\sqrt{B2})≤10000;
wherein, D50 is an average particle size of the lithium supplementing material;
B1 is a specific surface area of the lithium supplementing material;
B2 is a specific surface area of the conductive agent;
M1 is the ratio of the mass of the lithium supplementing material to the mass of solid components in the lithium supplementing slurry;
M2 is the ratio of the mass of the conductive agent to the mass of the solid components in the lithium supplementing slurry; and
M3 is the ratio of the mass of the binder to the mass of the solid components in the lithium supplementing slurry.

2. The lithium supplementing slurry according to claim 1, wherein the lithium supplementing material comprises at least one lithium-containing metal oxide that is capable of lithium deintercalation.

3. The lithium supplementing slurry according to claim 2, wherein, when the lithium supplementing material comprises at least two lithium-containing metal oxides, the ratio of the mass of the lithium supplementing material to the mass of the solid components in the lithium supplementing slurry is respectively calculated by M1a, M1 b, M1c, . . . , M1 n, the specific surface area of the lithium supplementing material is calculated by B1a, B1b, B1c, . . . , B1n, and the average particle size of the lithium supplementing material is calculated by D50a, D50b, D50c, . . . , D50n; and the following relational expressions are met: M1=M1a+M1b+M1c+ . . . +M1 n;
B1=M1a*B1a+M1b*B1b+ . . . +M1n*B1n; and
D50=M1a*D50a+M1b*D50b+ . . . +M1n*D50n.

4. The lithium supplementing slurry according to claim 3, wherein the specific surface area B1 of the lithium supplementing material is 0.3-15 m²/g; the average particle size D50 of the lithium supplementing material is 0.5-12 μm; and the ratio M1 of the mass of the lithium supplementing material to the mass of solid components in the lithium supplementing slurry is 70-95%.

5. The lithium supplementing slurry according to claim 2, wherein the lithium-containing metal oxide is any one of lithium phosphate, dilithium hydrogen phosphate, lithium sulfate, lithium sulfite, lithium molybdate, lithium oxalate, lithium titanate, lithium tetraborate, lithium metasilicate, lithium metamanganate, lithium tartrate, and trilithium citrate.

6. The lithium supplementing slurry according to claim 1, wherein the conductive agent consists of at least one conductive agent; when the conductive agent comprises at least two conductive agents, the ratio of the mass of the conductive agent to the mass of the solid components in the lithium supplementing slurry is respectively calculated by M2a, M2b, M2c, . . . , M2n, and the specific surface area of the conductive agent is calculated by B2a, B2b, B2c, . . . , B2n; and the following relational expressions are met:
M2=M2a+M2b+M2c+ . . . +M2n; and B2=M2a*B2a+M2b*B2b+ . . . +M2n*B2n.

7. The lithium supplementing slurry according to claim 6, wherein the specific surface area B2 of the conductive agent is 20-300 m²/g; and the ratio M2 of the mass of the conductive agent to the mass of solid components in the lithium supplementing slurry is 0.1-15%.

8. The lithium supplementing slurry according to claim 1, wherein the conductive agent comprises at least one of conductive carbon black, conductive graphite, Ketjen black, carbon fiber, carbon nanotubes, graphene, graphene oxide, or vapor grown carbon fiber.

9. The lithium supplementing slurry according to claim 1, wherein the binder is at least one of polyvinylpyrrolidone, polyvinylidene fluoride, polyethylene oxide, polytetrafluoroethylene, sodium carboxymethyl cellulose, or a copolymer of styrene and butadiene; and the ratio M3 of the mass of the binder to the mass of the solid components in the lithium supplementing slurry is 0.1-20%.

10. The lithium supplementing slurry according to claim 1, further comprising a dispersing agent, wherein the ratio of the dispersing agent to the mass of the solid components in the lithium supplementing slurry is 0.1-10%; and the dispersing agent is polyoxyethylene dioleate and/or polytetraethylene glycol monostearate.

11. The lithium supplementing slurry according to claim 1, further comprising a solvent, wherein the ratio of the solvent to the mass of the lithium supplementing slurry is 20-50%; and the solvent is at least one of water, N-methyl-2-pyrrolidone, tetrahydrofuran, N,N-dimethylformamide, or ethanol.

12. A positive electrode plate, comprising a positive electrode coating and a lithium supplementing coating coated on the positive electrode coating; and the lithium supplementing coating is prepared by the lithium supplementing slurry according to claim 1.

13. The positive electrode plate according to claim 12, wherein the thickness of the positive electrode coating and the thickness of the lithium supplementing coating meet the following relational expression: 1/10<the thickness of the lithium supplementing coating/the thickness of the positive electrode coating<⅓.

14. The positive electrode plate according to claim 13, wherein the thickness of the lithium supplementing coating is 5-100 μm; and the thickness of the positive electrode coating is 50-300 μm.

15. A lithium ion battery, comprising the positive electrode plate according to claim 12.

16. The lithium ion battery according to claim 15, wherein the thickness of the positive electrode coating and the thickness of the lithium supplementing coating meet the following relational expression: 1/10<the thickness of the lithium supplementing coating/the thickness of the positive electrode coating<⅓.

17. The lithium ion battery according to claim 16, wherein the thickness of the lithium supplementing coating is 5-100 μm; and the thickness of the positive electrode coating is 50-300 μm.
